(19) United States
(12) Patent Application Publication
(10) Pub. No.: US 2023/0134762 A1
(43) Pub. Date: May 4, 2023

(54) Apparatus, Method, and Computer Program

(71) Applicant: Nokia Technologies Oy, Espoo (FI)

(72) Inventors: Jarkko KOSKELA, Oulu (FI); Samuli TURTINEN, Ii (FI); Jussi-Pekka KOSKINEN, Oulu (FI); Chunli WU, Beijing (CN)

(21) Appl. No.: 17/767,515

(22) PCT Filed: Oct. 12, 2019
(86) PCT No.: PCT/CN2019/110835

§ 371 Date: Apr. 8, 2022

(51) Int. Cl. H04W 24/08; H04W 72/20

(52) U.S. Cl. CPC H04W 24/08; H04W 72/20

(57) ABSTRACT

An apparatus including at least one processor; and at least one memory including computer program code; the at least one memory and the computer program code configured to, with the at least one processor, cause the apparatus at least to: generate a configuration and/or a command for performing control channel monitoring skipping on multiple radio frequency resources; and provide the configuration and/or command for performing control channel monitoring skipping on the multiple radio frequency resources to the terminal.

### FIELD OF THE DISCLOSURE

The present disclosure relates to an apparatus, a method, and a computer program for managing control channel monitoring skipping on a plurality of radio frequency resources in a cellular network.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link.

A user can access the communication system by means of an appropriate communication device or terminal. A communication device of a user is often referred to as user equipment (UE) or user device. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known as the long-term evolution (LTE) or the Universal Mobile Telecommunications System (UMTS) radio-access technology. Another example communication system is so called 5G radio or new radio (NR) access technology.

### SUMMARY

According to an aspect there is provided an apparatus comprising at least one processor and at least one memory including computer code for one or more programs, the at least one memory and the computer code configured, with the at least one processor, to cause the apparatus at least to: generate a configuration and/or a command for performing control channel monitoring skipping on multiple radio frequency resources; and provide the configuration and/or command for performing control channel monitoring skipping on the multiple radio frequency zo resources to the terminal.

The at least one memory and the computer program code may be configured to, with the at least one processor, cause the apparatus at least to: generate a configuration and/or a command for performing control channel monitoring skipping on a group of multiple radio frequency resources; and provide the configuration and/or command for performing control channel monitoring skipping on the group of multiple radio frequency resources to the terminal.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some of the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprise an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources may be provided via lower layer signalling.

The configuration for performing control channel monitoring skipping on the multiple radio frequency resources may be provided prior to the command for performing control channel monitoring skipping on the multiple radio frequency resources.

The terminal may be in a radio resource control connected mode.

The apparatus may be a base station.

According to an aspect there is provided an apparatus comprising circuitry configured to: generate a configuration and/or a command for performing control channel monitoring skipping on multiple radio frequency resources; and provide the configuration and/or command for performing control channel monitoring skipping on the multiple radio frequency resources to the terminal.

The apparatus may comprise circuitry configured to: generate a configuration and/or a command for performing control channel monitoring skipping on a group of multiple radio frequency resources; and provide the configuration and/or command for performing control channel monitoring skipping on the group of multiple radio frequency resources to the terminal.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some of the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprise an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources may be provided via lower layer signalling.

The configuration for performing control channel monitoring skipping on the multiple radio frequency resources may be provided prior to the command for performing control channel monitoring skipping on the multiple radio frequency resources.

The terminal may be in a radio resource control connected mode.

The apparatus may be a base station.

According to an aspect there is provided an apparatus comprising means for: generating a configuration and/or a command for performing control channel monitoring skipping on multiple radio frequency resources; and providing the configuration and/or command for performing control channel monitoring skipping on the multiple radio frequency resources to the terminal.

The apparatus may comprise means for: generating a configuration and/or a command for performing control channel monitoring skipping on a group of multiple radio frequency resources; and providing the configuration and/or command for performing control channel monitoring skipping on the group of multiple radio frequency resources to the terminal.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some of the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprise an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources may be provided via lower layer signalling.

The configuration for performing control channel monitoring skipping on the multiple radio frequency resources may be provided prior to the command for performing control channel monitoring skipping on the multiple radio frequency resources.

The terminal may be in a radio resource control connected mode.

The apparatus may be a base station

According to an aspect there is provided a method comprising: generating a configuration and/or a command for performing control channel monitoring skipping on multiple radio frequency resources; and providing the configuration and/or command for performing control channel monitoring skipping on the multiple radio frequency resources to the terminal.

The method may comprise: generating a configuration and/or a command for performing control channel monitoring skipping on a group of multiple radio frequency resources; and providing the configuration and/or command for performing control channel monitoring skipping on the group of multiple radio frequency resources to the terminal.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some of the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprise an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources may be provided via lower layer signalling.

The configuration for performing control channel monitoring skipping on the multiple radio frequency resources may be provided prior to the command for performing control channel monitoring skipping on the multiple radio frequency resources.

The terminal may be in a radio resource control connected mode.

The method may be performed by a base station.

According to an aspect there is provided a computer program comprising computer executable code which when run on at least one processor is configured to: generate a configuration and/or a command for performing control channel monitoring skipping on multiple radio frequency resources; and provide the configuration and/or command for performing control channel monitoring skipping on the multiple radio frequency resources to the terminal.

The computer program may comprise computer executable code which when run on at least one processor is configured to: generate a configuration and/or a command for performing control channel monitoring skipping on a group of multiple radio frequency resources; and provide the configuration and/or command for performing control channel monitoring skipping on the group of multiple radio frequency resources to the terminal.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some of the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprise an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources may be provided via lower layer signalling.

The configuration for performing control channel monitoring skipping on the multiple radio frequency resources may be provided prior to the command for performing control channel monitoring skipping on the multiple radio frequency resources.

The terminal may be in a radio resource control connected mode.

The at least one processor may be part of a base station.

According to an aspect there is provided an apparatus comprising at least one processor and at least one memory including computer code for one or more programs, the at least one memory and the computer code configured, with the at least one processor, to cause the apparatus at least to: receive a configuration and/or a command for performing control channel monitoring skipping on multiple radio frequency resources; and use the configuration and/or the command for performing control channel monitoring skipping on the multiple radio frequency resources.

The at least one memory and the computer program code may be configured to, with the at least one processor, cause the apparatus at least to: receive a configuration and/or a command for performing control channel monitoring skipping on a group of multiple radio frequency resources; and use the configuration and/or the command for performing control channel monitoring skipping on the group of multiple radio frequency resources

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprises an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources is provided via lower layer signalling.

The configuration for performing control channel monitoring skipping on the multiple radio frequency resources may be provided prior to the command for performing control channel monitoring skipping on the multiple radio frequency resources.

The apparatus may be a terminal.

The terminal may be in a radio resource control connected mode.

According to an aspect there is provided an apparatus comprising circuitry configured to: receive a configuration and/or a command for performing control channel monitoring skipping on multiple radio frequency resources; and use the configuration and/or the command for performing control channel monitoring skipping on the multiple radio frequency resources.

The apparatus may comprise circuitry configured to: receive a configuration and/or a command for performing control channel monitoring skipping on a group of multiple radio frequency resources; and use the configuration and/or the command for performing control channel monitoring skipping on the group of multiple radio frequency resources.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprises an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources is provided via lower layer signalling.

The configuration for performing control channel monitoring skipping on the multiple radio frequency resources may be provided prior to the command for performing control channel monitoring skipping on the multiple radio frequency resources.

The apparatus may be a terminal.

The terminal may be in a radio resource control connected mode.

According to an aspect there is provided an apparatus comprising means for: receiving a configuration and/or a command for performing control channel monitoring skipping on multiple radio frequency resources; and using the configuration and/or the command for performing control channel monitoring skipping on the multiple radio frequency resources.

The apparatus may comprise means for: receiving a configuration and/or a command for performing control channel monitoring skipping on a group of multiple radio frequency resources; and using the configuration and/or the command for performing control channel monitoring skipping on the group of multiple radio frequency resources.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprises an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources is provided via lower layer signalling.

The configuration for performing control channel monitoring skipping on the multiple radio frequency resources may be provided prior to the command for performing control channel monitoring skipping on the multiple radio frequency resources.

The apparatus may be a terminal.

The terminal may be in a radio resource control connected mode.

According to an aspect there is provided a method comprising: <receiving a configuration and/or a command for performing control channel monitoring skipping on multiple radio frequency resources; and using the configuration and/or the command for performing control channel monitoring skipping on the multiple radio frequency resources.

The method may comprise: receiving a configuration and/or a command for performing control channel monitoring skipping on a group of multiple radio frequency resources; and using the configuration and/or the command for performing control channel monitoring skipping on the group of multiple radio frequency resources.

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprises an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources is provided via lower layer signalling.

The configuration for performing control channel monitoring skipping on the multiple radio frequency resources may be provided prior to the command for performing control channel monitoring skipping on the multiple radio frequency resources.

The method may be performed by a terminal.

The terminal may be in a radio resource control connected mode.

According to an aspect there is provided a computer program comprising computer executable code which when run on at least one processor is configured to: receive a configuration and/or a command for performing control channel monitoring skipping on multiple radio frequency resources; and use the configuration and/or the command for performing control channel monitoring skipping on the multiple radio frequency resources.

The computer program may comprise computer executable code which when run on at least one processor is configured to: receive a configuration and/or a command for performing control channel monitoring skipping on a group of multiple radio frequency resources; and use the configuration and/or the command for performing control channel monitoring skipping on the group of multiple radio frequency resources

The control channel may be a physical downlink control channel.

The multiple radio frequency resources may comprise multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources and wherein the configuration for performing control channel monitoring skipping on the multiple radio frequency resources comprises an indication indicating some the set of radio frequency resources.

The multiple radio frequency resources may comprise all of a set of radio frequency resources and wherein the configuration for performing control channel monitoring skipping on the multiple radio frequency resources comprises an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprises an indication indicating a time period during which control channel monitoring skipping is allowed on the multiple radio frequency resources.

The command for performing control channel monitoring skipping on the multiple radio frequency resources may comprise an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources is provided via lower layer signalling.

The configuration for performing control channel monitoring skipping on the multiple radio frequency resources may be provided prior to the command for performing control channel monitoring skipping on the multiple radio frequency resources.

The at least one processor may be part of a terminal.

The terminal may be in a radio resource control connected mode.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function

AUSF: Authentication Server Function

AMF: Access Management Function

BFR: Beam Failure Recovery

BS: Base Station

BWP: BandWidth Part

C-DRX: Connected mode Discontinous Reception

CU: Centralized Unit

DCI: Downlink Control Information

DN: Data Network

DRX: Discontinous Reception

DU: Distributed Unit

GNB: gNodeB

GSM: Global System for Mobile communication

HSS: Home Subscriber Server

IE: Information Element

IoT: Internet of Things

IP: Internet Protocol

L2: Layer 2

LTE: Long Term Evolution

MAC: Medium Access Control

NEF: Network Exposure Function

NR: New Radio

MS: Mobile Station

MTC: Machine Type Communication

PDCCH: Physical Downlink Control Channel

PHY: Physical

RA: Random Access

RAM: Random Access Memory

RAN: Radio Access Network

RF: Radio Frequency

ROM: Read Only Memory

RRM: Radio Resource Management

SI: Study Item

SIB: System Information Block

SMF: Session Management Function

SR: Scheduling Request

UDM: User Data Management

UE: User Equipment

UMTS: Universal Mobile Telecommunication System

USB: Universal Serial Bus

WI: Work Item

WUS: Wake up signal

3GPP: 3^{rd} Generation Partnership Project

5G: 5^{th} Generation

5GC: 5G Core network

5GRAN: 5G Radio Access Network

5GS: 5G System

### BRIEF DESCRIPTION OF THE FIGURES

Embodiments will now be described, by way of example only, with reference to the accompanying Figures in which:

FIG. 1 shows a schematic representation of a 5G system (5GS);

FIG. 2 shows a schematic representation of a control apparatus;

FIG. 3 shows a schematic representation of a terminal;

FIG. 4 shows a schematic representation of DCI based PDCCH monitoring skipping;

FIG. 5 shows a schematic representation of a signalling diagram of a process wherein a next generation Node B configures a user equipment with multiple groups including multiple serving cells for which physical downlink control channel monitoring skipping is allowed and wherein the next generation Node B triggers physical downlink control channel monitoring skipping for one of the multiple groups including multiple serving cells at the user equipment;

FIG. 6 shows a schematic representation of a signalling diagram of a process wherein a next generation Node B configures a user equipment with multiple downlink control information associated with multiple serving cells for which physical downlink control channel monitoring skipping is allowed and wherein the next generation Node B triggers physical downlink control channel monitoring skipping for one of the multiple downlink control information associated with multiple serving cells at the user equipment;

FIG. 7 shows a schematic representation of a signalling diagram of a process wherein a next generation Node B triggers physical downlink control channel monitoring skipping for multiple serving cells at a user equipment;

FIG. 8 shows a schematic representation of a method of managing skipping control channel monitoring on a plurality of radio frequency resources in a cellular network performed by a base station (e.g. next generation Node B);

FIG. 9 shows a schematic representation of a method of managing skipping control channel monitoring on a plurality of radio frequency resources in a cellular network performed by a terminal (e.g. user equipment); and

FIG. 10 shows a schematic representation of a non-volatile memory medium storing instructions which when executed by a processor allow a processor to perform one or more of the steps of the method of any of FIGS. 8 and 9.

### DETAILED DESCRIPTION OF THE FIGURES

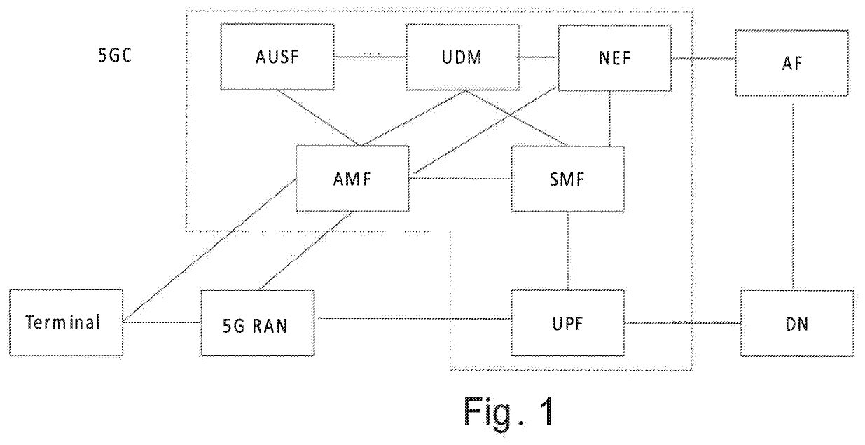

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a terminal, a 5G radio access network (5GRAN), a 5G core network (5GC), one or more application function (AF) and one or more data networks (DN).

The 5GRAN may comprise one or more gNodeB (GNB) distributed unit functions connected to one or more gNodeB (GNB) centralized unit functions.

The 5GC may comprise an access management function (AMF), a session management function (SMF), an authentication server function (AUSF), a user data management (UDM), a user plane function (UPF) and/or a network exposure function (NEF).

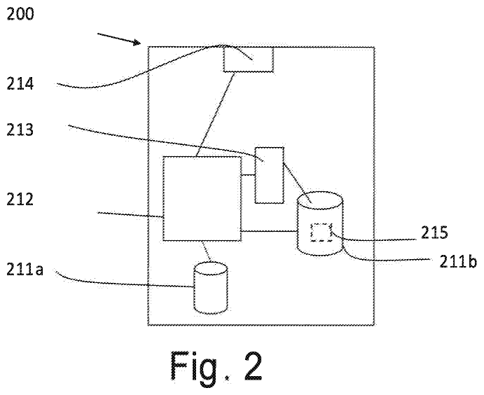

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

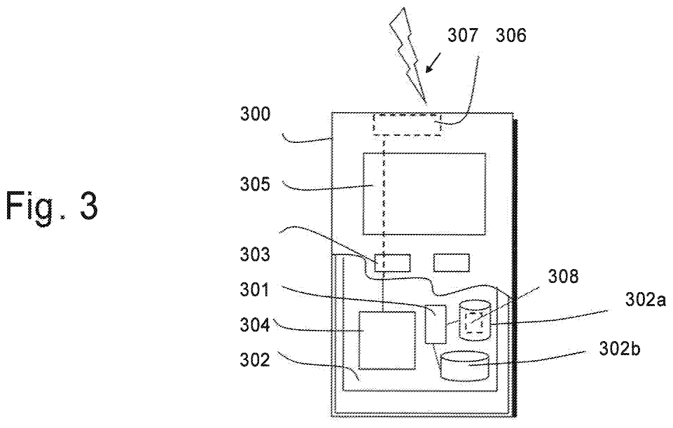

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dangle), a personal data assistant (PDA) or a tablet provided with wireless communication capabilities, a machine-type communications (MTC) device, an Internet of things (loT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 211b. The at least one processor 301 may be configured to execute an appropriate software code 308. The software code 308 may for example allow to perform one or more of the present aspects. The software code 308 may be stored in the ROM 302b.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

One or more of the following aspects relate to performing power savings in 5GS. However, it will be understood that similar aspects may relate to other systems.

Various techniques have been proposed to perform power savings in 5GS including wake up signalling (WUS), skipping physical downlink control channel (PDCCH) monitoring or discontinuous reception (DRX).

WUS and skipping PDCCH monitoring are discussed in the power saving study item (SI) RP-181463. DRX has been supported for power saving since LTE Rel-8 and for NR as well.

With skipping PDCCH monitoring, downlink control information (DCI) may be used to indicate a UE to skip PDCCH monitoring for certain periods.

With DRX, DRX cycles may keep a UE awake periodically during OnDuration in case data transmission may be needed. An active time may be extended by scheduling the UE with an inactivity timer when there is data transmission ongoing.

With WUS, WUS occasions may be configured before an OnDuration with a certain offset and a UE may perform monitoring during the OnDuration if there is a WUS indicating the UE to do so. There may be open issues as to whether the WUS should explicitly indicate whether the UE should perform monitoring during the OnDuration and/or implicitly indicate whether the UE should perform monitoring during the OnDuration (i.e. whether an absence of WUS implicitly indicates the UE should abstain from performing monitoring during the OnDuration).

Based on scheduling decisions and/or absence of data in a buffer, the DCI may command a UE to skip PDCCH monitoring on one or more occasions. It has been left for further study how the extent of skipping PDCCH monitoring is indicated (number of occasions, time period, etc.) and if the extent of skipping PDCCH monitoring is radio resource control (RRC) configured and/or dynamically indicated in the DCI.

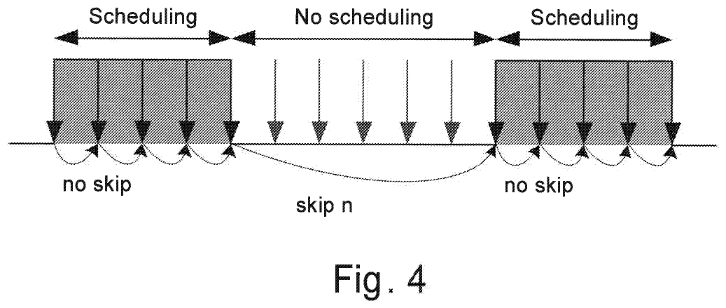

FIG. 4 shows a schematic representation of DCI based PDCCH monitoring skipping. A UE may abstain from skipping PDCCH monitoring during scheduling periods and may skip PDCCH monitoring during a no scheduling period. The no scheduling period may comprise N PDCCH occasions, where N is an integer equal to one or greater than one.

RAN2 agreed the following in RAN2# 105b is meeting. A UE may indicate to the network preferences for transitioning out of a RRC_CONNECTED mode. It may be for further study what UE assistance may be provided and for what scenario. UE assistance for DRX configuration will be studied. RAN2 will study RAN2 impact of wake up signaling to connected mode DRX (C-DRX). Wakeup signaling may be linked to C-DRX and may only be configured when C-DRX is configured. If the WUS is not configured legacy operations may apply. If configured with WUS, a UE may monitor for WUS occasions at a known offset before on duration C-DRX. The offset may be up to RAN1 discussion.

From RAN2# 106 work item (WI) recommendations for WI objectives have been agreed. The higher layer procedure in support of DCI-based PDCCH monitoring skipping (which can include DCI-based PDCCH monitoring skipping periodicity adaptation) was studied to achieve PDCCH monitoring/decoding reduction (section 5.1.5). If enabled, it may be assumed that DCI-based PDCCH monitoring skipping may be configured with or without C-DRX. However, RAN2 did not reach consensus on the benefit of using PDCCH monitoring skipping without C-DRX. DCI-based PDCCH monitoring skipping may be aimed to operate on a short time scale (i.e. shorter time scale than the layer 2 (L2) C-DRX). Under this condition, it has not been identified that DCI-based PDCCH monitoring skipping may duplicate the C-DRX functionality. The common understanding is that DCI-based PDCCH monitoring skipping should be a physical layer (PHY) procedure with minimal impact, if any, on the medium access control (MAC) layer. The MAC timers may not be affected by DCI-based PDCCH monitoring skipping commands, except for timers related to uplink triggered activities (e.g. random access (RA), scheduling request (SR) and beam failure recovery (BFR)), which should be addressed in the WI phase, namely how/if the DCI-based PDCCH monitoring skipping command impacts L2 operation while a RA or SR procedure is on-going.

In carrier aggregation operation a UE will have multiple serving carriers and in order to maximise benefits of power saving it may be desirable to be able to configure PDCCH monitoring skipping separately for multiple serving carriers per serving carrier.

In order to enable PDCCH monitoring skipping to be controllable with more granularity a gNB may configure a UE to perform PDCCH monitoring skipping as follows.

The gNB may configure a group of multiple carriers, component carriers, cells, serving cells, frequency ranges, frequency bands and/or radio access technologies for which PDCCH monitoring skipping is valid (i.e. allowed).

The group of multiple carriers, component carriers, cells, serving cells, frequency ranges, frequency bands and/or radio access technologies for which PDCCH monitoring skipping is valid may comprise some or all carriers, component carriers, cells, serving cells, frequency ranges, frequency bands and/or radio access technologies for which there is a PDCCH.

The gNB may configure a single time period during which PDCCH monitoring skipping is valid on the group of multiple carriers, component carriers, cells, serving cells, frequency ranges, frequency bands and/or radio access technologies (i.e. a common time period for the multiple carriers, component carriers, cells, serving cells, frequency ranges, frequency bands and/or radio access technologies).

Alternatively, the gNB may configure multiple time periods during which PDCCH monitoring skipping is valid on the group of multiple carriers, component carriers, cells, serving cells, frequency ranges, frequency bands and/or radio access technologies (i.e. individual time periods for the multiple carriers, component carriers, cells, serving cells, frequency ranges, frequency bands and/or radio access technologies).

The gNB may command the triggering of PDCCH monitoring skipping on the group of multiple carriers, component carriers, cells, serving cells, frequency ranges, frequency bands and/or radio access technologies configured by the gNB.

The gNB may provide the configuration and/or the command for performing PDCCH monitoring skipping on the multiple carriers, component carriers, cells, serving cells, frequency ranges, frequency bands and/or radio access technologies to the UE. The configuration may be provided via higher layer (e.g. MAC or RRC) signalling. The configuration may be provided via one or more information elements (IE). The command may be provided via lower layer (e.g. PHY) signalling. The configuration may be provided prior to the command. Alternatively, the configuration may be provided simultaneously with or subsequent to the command.

The UE may perform PDCCH monitoring skipping on the group of multiple carriers, component carriers, cells, serving cells, frequency ranges, frequency bands and/or radio access technologies based on the configuration and/or the command.

In an implementation, the gNB may configure multiple groups of multiple carriers, component carriers, cells, serving cells, frequency ranges, frequency bands and/or radio access technologies of the multiple groups of multiple carriers, component carriers, cells, serving cells, frequency ranges, frequency bands and/or radio access technologies for which PDCCH monitoring skipping is valid (i.e. allowed).

The multiple carriers, component carriers, cells, serving cells, frequency ranges, frequency bands and/or radio access technologies for which PDCCH monitoring skipping is valid may comprise some or all of the carriers, component carriers, cells, serving cells, frequency ranges, frequency bands and/or radio access technologies for which there is a PDCCH.

The gNB may configure groups of multiple carriers, component carriers, cells, serving cells, frequency ranges, frequency bands and/or radio access technologies of the multiple groups of multiple carriers, component carriers, cells, serving cells, frequency ranges, frequency bands and/or radio access technologies for which PDCCH monitoring skipping is invalid (i.e. not allowed).

The multiple carriers, component carriers, cells, serving cells, frequency ranges, frequency bands and/or radio access technologies for which PDCCH monitoring skipping is not valid may comprise some or all of the carriers, component carriers, cells, serving cells, frequency ranges, frequency bands and/or radio access io technologies for which there is a PDCCH.

The gNB may configure a single time period during which PDCCH monitoring skipping is valid on the multiple groups of multiple carriers, component carriers, cells, serving cells, frequency ranges, frequency bands and/or radio access technologies (i.e. a common time period for the multiple groups of multiple carriers, component carriers, cells, serving cells, frequency ranges, frequency bands and/or radio access technologies).

Alternatively, the gNB may configure multiple time periods during which PDCCH monitoring skipping is valid on the multiple groups of multiple carriers, component carriers, cells, serving cells, frequency ranges, frequency bands and/or radio access technologies (i.e. individual time periods for the multiple groups of multiple carriers, component carriers, cells, serving cells, frequency ranges, frequency bands and/or radio access technologies).

The gNB may command the triggering of PDCCH monitoring skipping on the multiple groups of multiple carriers, component carriers, cells, serving cells, frequency ranges, frequency bands and/or radio access technologies configured by the gNB.

The gNB may provide the configuration and/or the command for performing PDCCH monitoring skipping on the multiple groups of multiple carriers, component carriers, cells, serving cells, frequency ranges, frequency bands and/or radio access technologies. The configuration may be provided via higher layer (e.g. MAC or RRC) signalling. The configuration may be provided via one or more information elements (IE). The command may be provided via lower layer (e.g. PHY) signalling. The configuration may be provided prior to the command. Alternatively, the configuration may be provided simultaneously with or subsequent to the command.

The UE may perform PDCCH monitoring skipping on the multiple groups of multiple carriers, component carriers, cells, serving cells, frequency ranges, frequency bands and/or radio access technologies based on the configuration and/or the command.

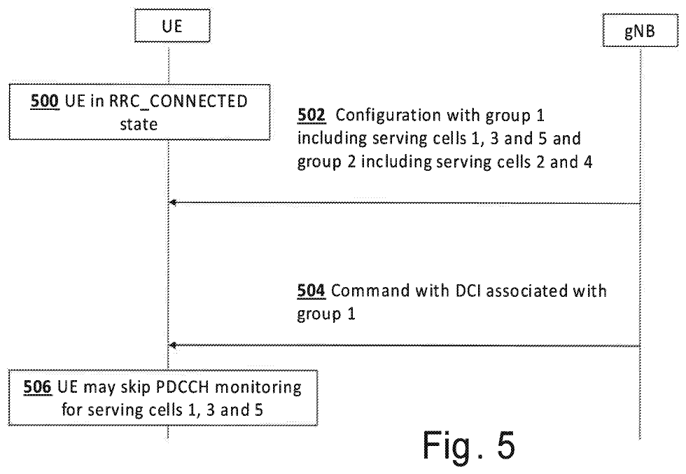

FIG. 5 shows a schematic representation of a signalling diagram of a process wherein a gNB configures a UE with multiple groups of multiple serving cells for which PDCCH monitoring skipping is allowed and wherein the gNB triggers PDCCH monitoring skipping for one of the multiple groups of multiple serving cells at the UE.

In step 500 the UE may operate in RRC_CONNECTED mode.

In step 502 the gNB may provide a configuration to the UE for performing PDCCH monitoring skipping. The configuration may comprise an indication indicating that group 1 includes serving cells 1, 3 and 5 and group 2 includes serving cell 2 and 4. Serving cells 1, 2, 3, 4 and 5 may be serving cells for which there is a PDCCH. The gNB may also provide an indication to the UE indicating that PDCCH monitoring skipping is valid for group 1 and group 2. The configuration may be provided via higher layer signalling.

In step 504 the gNB may provide a command to the UE for performing PDCCH monitoring skipping. The command may comprise an indication triggering PDCCH monitoring skipping on serving cells 1, 3 and 5. The indication may be a DCI associated with group 1. The command may be provided via lower layer signalling.

In step 506 the UE may perform PDCCH monitoring skipping based on the configuration and the command. The UE may perform PDCCH monitoring skipping for serving cells 1, 3 and 5.

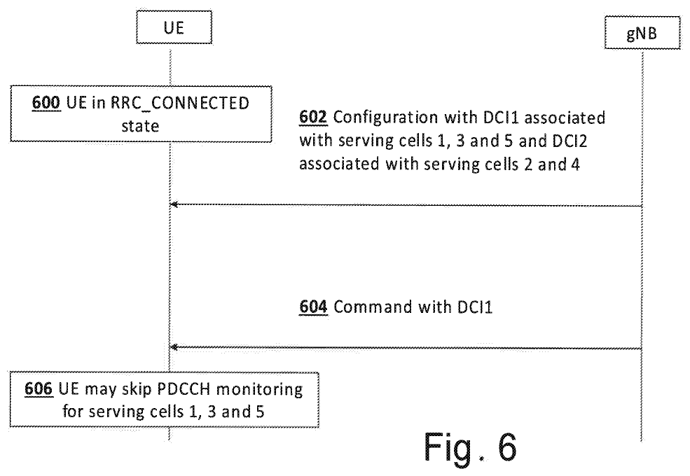

FIG. 6 shows a schematic representation of a signalling diagram of a process wherein a gNB configures a UE with multiple DCI associated with multiple serving cells for which PDCCH monitoring skipping is allowed and wherein the gNB triggers PDCCH monitoring skipping for one of the multiple DCI associated with multiple serving cells at the UE.

In step 600 the UE may operate in RRC_CONNECTED mode.

In step 602 the gNB may provide a configuration to the UE for performing PDCCH monitoring skipping. The configuration may comprise an indication indicating that DCI1 is associated with serving cells 1, 3 and 5 and DCI2 is associated with serving cell 2 and 4. Serving cells 1, 2, 3, 4 and 5 may be serving cells for which there is a PDCCH. The gNB may also provide an indication to the UE indicating that PDCCH monitoring skipping is valid for DCI1 and DCI2. The configuration may be provided via higher layer signalling.

In step 604 the gNB may provide a command to the UE for performing PDCCH monitoring skipping. The command may comprise an indication triggering PDCCH monitoring skipping on serving cells 1, 3 and 5. The indication may be DCI1 associated with serving cells 1, 3 and 5. The command may be provided via lower layer signalling.

In step 606 the UE may perform PDCCH monitoring skipping based on the configuration and the command. The UE may perform PDCCH monitoring skipping for serving cells 1, 3 and 5.

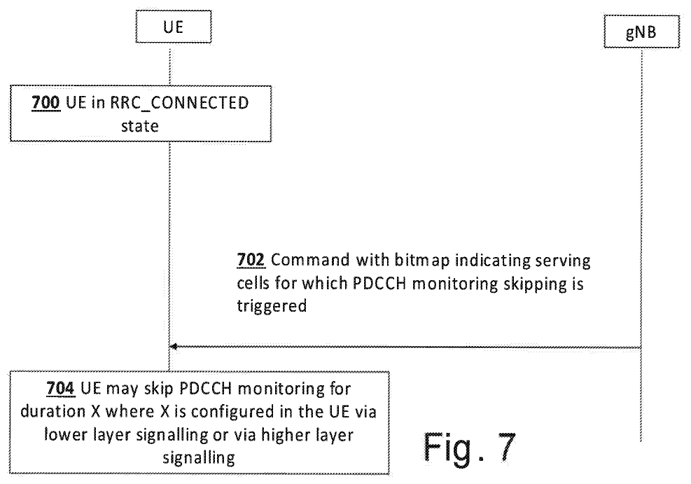

FIG. 7 shows a schematic representation of a signalling diagram of a process wherein a gNB triggers PDCCH monitoring skipping for multiple serving cells at a UE.

In step 700 the UE may operate in RRC_CONNECTED mode.

In step 702 the gNB may provide a command to the UE for performing PDCCH monitoring skipping. The command may comprise an indication triggering PDCCH monitoring skipping on specific serving cells. The indication may comprise a bitmap. The command may be provided via lower layer signalling.

In step 704 the UE may perform PDCCH monitoring skipping based on the command. The UE may perform PDCCH monitoring skipping for the specific serving cells for a duration X, where X is a time period configured in the UE via lower layer signalling (e.g. separately or with the command) or via higher layer signalling.

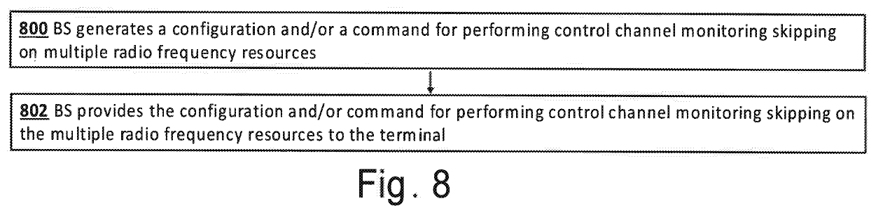

FIG. 8 shows a schematic representation of a method of managing skipping control channel monitoring on a plurality of radio frequency resources in a cellular network performed by base station (e.g. gNB).

In step 800 the base station may generate a configuration and/or a command for performing control channel monitoring skipping on multiple radio frequency resources. In an implementation, the base station may generate a configuration and/or a command for performing control channel monitoring skipping on a group of multiple radio frequency resources.

The control channel may be the PDCCH.

The multiple radio frequency resources comprises multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources for which there is a control channel. The configuration for performing control channel monitoring skipping on the multiple radio frequency resources may then comprise an indication indicating some of the set of radio frequency resources only.

Alternatively, the multiple radio frequency resources may comprise all of a set of radio frequency resources for which there is a control channel d. The configuration for performing control channel monitoring skipping on the multiple radio frequency resources may then comprise an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprise an indication indicating a time period during which control channel monitoring skipping is allowed on the multiple radio frequency resources.

The command for performing control channel monitoring skipping on the multiple radio frequency resources may comprises an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources may be provided via lower layer signalling.

The configuration for performing control channel monitoring skipping on the multiple radio frequency resources may be provided prior to the command for performing control channel monitoring skipping on the multiple radio frequency resources.

The terminal may be in a radio resource control connected mode.

In step 802 the base station may provide the configuration and/or command for performing control channel monitoring skipping on the multiple radio frequency resources to the terminal. In an implementation, the base station may provide the configuration and/or command for performing control channel monitoring skipping on a group of multiple radio frequency resources to the terminal.

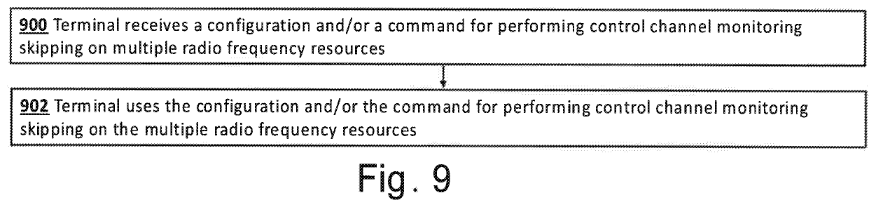

FIG. 9 shows a schematic representation of a method of managing skipping control channel monitoring on a plurality of radio frequency resources in a cellular network performed by a terminal (e.g. UE).

In step 900 the terminal may receive a configuration and/or a command for performing control channel monitoring skipping on multiple radio frequency resources. In an implementation, the terminal may receive a configuration and/or a command for performing control channel monitoring skipping on a group of multiple radio frequency resources.

The control channel may be the PDCCH.

The multiple radio frequency resources comprises multiple frequency carriers, multiple component carriers, multiple frequency bands, multiple frequency bands, multiple cells, multiple serving cells and/or multiple radio access technologies.

The multiple radio frequency resources may comprise some of a set of radio frequency resources for which there is a control channel. The configuration for performing control channel monitoring skipping on the multiple radio frequency resources may then comprise an indication indicating some of the set of radio frequency resources only.

Alternatively, the multiple radio frequency resources may comprise all of a set of radio frequency resources for which there is a control channel d. The configuration for performing control channel monitoring skipping on the multiple radio frequency resources may then comprise an indication indicating all of the set of radio frequency resources.

The configuration for performing control channel monitoring skipping on the multiple radio frequency resources may comprise an indication indicating whether control channel monitoring skipping is allowed on the multiple radio frequency resources.

The configuration for performing control channel monitoring skipping on the multiple radio frequency resources may comprise an indication indicating a time period during which control channel monitoring skipping is allowed on the multiple radio frequency resources.

The command for performing control channel monitoring skipping on the multiple radio frequency resources may comprises an indication triggering control channel monitoring skipping on the multiple radio frequency resources.

The configuration for performing control channel monitoring skipping on the multiple radio frequency resources may be provided via higher layer signalling and the command for performing control channel monitoring skipping on the multiple radio frequency resources may be provided via lower layer signalling.

The configuration for performing control channel monitoring skipping on the multiple radio frequency resources may be provided prior to the command for performing control channel monitoring skipping on the multiple radio frequency resources.

The terminal may be in a radio resource control connected mode.

In step 902 the terminal may use the configuration and/or the command for performing control channel monitoring skipping on the multiple radio frequency resources. In an implementation, the terminal may use the configuration and/or the command for performing control channel monitoring skipping on the group of multiple radio frequency resources.

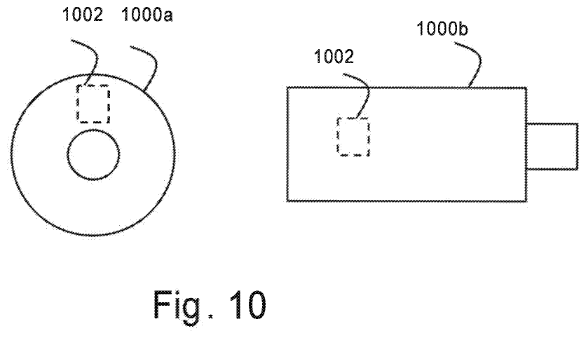

FIG. 10 shows a schematic representation of non-volatile memory media 1000a (e.g. computer disc (CD) or digital versatile disc (DVD)) and 1000b (e.g. universal serial bus (USB) memory stick) storing instructions and/or parameters 1002 which when executed by a processor allow the processor to perform one or more of the steps of the methods of FIGS. 8 and 9.

The aspects described above are advantageous in that they allow using PDDCH monitoring skipping for multiple carriers, component carriers, cells, serving cells, frequency ranges, frequency bands and/or radio access technologies as opposed to using PDDCH monitoring skipping for a single carrier, component carrier, cell, serving cell, frequency range, frequency band and/or radio access technology.

The aspects described above are advantageous in that they allow UE battery saving gains from efficient PDCCH monitoring skipping.

The aspects described above are advantageous in that they allow PDCCH monitoring skipping feature for mixed setup where not all cells support PDCCH monitoring skipping (i.e. PDCCH monitoring skipping may be used only for the cells supporting PDCCH monitoring skipping).

It will be understood that although the above aspects have been described in relation to indication indicating a control channel (such as PDCCH) monitoring skipping, it may apply to indication indicating whether to monitor the control channel or not (such as WUS indication). In such case, for example, the WUS indication may indicate UE to monitor PDCCH on certain frequency resources but not all. Hence, it should be understood the WUS can be the indication indicating the control channel monitoring skipping.

It will be understood that although the above aspects have been describe in relation to a 5GS it may be application to other systems.

It will also be understood that although the above aspects have been describe in relation to PDCCH it may be application to other control channels.

It is noted that while the above describes example embodiments, there are several variations and modifications which may be made to the disclosed solution without departing from the scope of the present invention.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 8 and 9, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one non-transitory memory including computer program code;
the at least one memory and the computer program code configured to, with the at least one processor, cause the apparatus at least to:
generate a configuration and/or a command for performing control channel monitoring skipping on multiple radio frequency resources; and
provide the configuration and/or command for performing control channel monitoring skipping on the multiple radio frequency resources to the terminal.

2. The apparatus of claim 1, wherein the at least one memory and the computer program code are configured to, with the at least one processor, cause the apparatus at least to:
generate a configuration and/or a command for performing control channel monitoring skipping on a group of multiple radio frequency resources; and
provide the configuration and/or command for performing control channel monitoring skipping on the group of multiple radio frequency resources to the terminal.

3. (canceled)

4. The apparatus of claim 1, wherein the multiple radio frequency resources comprises multiple frequency carriers, multiple component carriers, multiple frequency bands, multiple frequency bands, multiple cells, multiple serving cells and/or multiple radio access technologies.

5. The apparatus of claim 1, wherein the multiple radio frequency resources comprises some of a set of radio frequency resources and wherein the configuration for performing control channel monitoring skipping on the multiple radio frequency resources comprises an indication indicating some of the set of radio frequency resources.

6. The apparatus of claim 1, wherein the multiple radio frequency resources comprises all of a set of radio frequency resources and wherein the configuration for performing control channel monitoring skipping on the multiple radio frequency resources comprises an indication indicating all of the set of radio frequency resources.

7. The apparatus of claim 1, wherein the configuration for performing control channel monitoring skipping on the multiple radio frequency resources comprises an indication indicating whether control channel monitoring skipping is allowed on the multiple radio frequency resources.

8. The apparatus of claim 1, wherein the configuration for performing control channel monitoring skipping on the multiple radio frequency resources comprises an indication indicating a time period during which control channel monitoring skipping is allowed on the multiple radio frequency resources.

9. The apparatus of claim 1, wherein the command for performing control channel monitoring skipping on the multiple radio frequency resources comprises an indication triggering control channel monitoring skipping on the multiple radio frequency resources.

10-13. (canceled)

14. An apparatus comprising:
at least one processor; and
at least one non-transitory memory including computer program code;
the at least one memory and the computer program code configured to, with the at least one processor, cause the apparatus at least to:
receive a configuration and/or a command for performing control channel monitoring skipping on multiple radio frequency resources; and
use the configuration and/or the command for performing control channel monitoring skipping on the multiple radio frequency resources.

15. The apparatus of claim 14, the at least one memory and the computer program code are configured to, with the at least one processor, cause the apparatus at least to:
receive a configuration and/or a command for performing control channel monitoring skipping on a group of multiple radio frequency resources; and
use the configuration and/or the command for performing control channel monitoring skipping on the group of multiple radio frequency resources.

16. The apparatus of claim 14, wherein the control channel is a physical downlink control channel.

17. The apparatus of claim 14, wherein the multiple radio frequency resources comprises multiple frequency carriers, multiple component carriers, multiple frequency bands, multiple frequency bands, multiple cells, multiple serving cells and/or multiple radio access technologies.

18. The apparatus of claim 14, wherein the multiple radio frequency resources comprises some of a set of radio frequency resources and wherein the configuration for performing control channel monitoring skipping on the multiple radio frequency resources comprises an indication indicating some the set of radio frequency resources.

19. The apparatus of claim 14, wherein the multiple radio frequency resources comprises all of a set of radio frequency resources and wherein the configuration for performing control channel monitoring skipping on the multiple radio frequency resources comprises an indication indicating all of the set of radio frequency resources.

20. The apparatus of claim 14, wherein the configuration for performing control channel monitoring skipping on the multiple radio frequency resources comprises an indication indicating whether control channel monitoring skipping is allowed on the multiple radio frequency resources.

21. The apparatus of claim 14, wherein the configuration for performing control channel monitoring skipping on the multiple radio frequency resources comprises an indication indicating a time period during which control channel monitoring skipping is allowed on the multiple radio frequency resources.

22. The apparatus of claim 14, wherein the command for performing control channel monitoring skipping on the multiple radio frequency resources comprises an indication triggering control channel monitoring skipping on the multiple radio frequency resources.

23. The apparatus of claim 14, wherein the configuration for performing control channel monitoring skipping on the multiple radio frequency resources is provided via higher layer signalling and the command for performing control channel monitoring skipping on the multiple radio frequency resources is provided via lower layer signalling.

24. The apparatus of claim 14, wherein the configuration for performing control channel monitoring skipping on the multiple radio frequency resources is provided prior to the command for performing control channel monitoring skipping on the multiple radio frequency resources.

25-27. (canceled)

28. A method comprising:
receiving a configuration and/or a command for performing control channel monitoring skipping on multiple radio frequency resources; and
using the configuration and/or the command for performing control channel monitoring skipping on the multiple radio frequency resources.

29. A non-transitory computer readable medium comprising computer executable instructions which, when run on one or more processors, perform the steps of claim 28.
